(19) United States
(12) Patent Application Publication
(10) Pub. No.: US 2025/0135825 A1
(43) Pub. Date: May 1, 2025

(54) SYSTEM, ASSEMBLY AND METHOD OF MOUNTING A SHOCK ABSORBER TO A VEHICLE

(71) Applicant: RV Ride Control, LLC, Maricopa, AZ (US)

(72) Inventors: Robert F. Mater, JR., Newnan, GA (US); Audreg R. Dismuke, Maricopa, AZ (US)

(21) Appl. No.: 18/385,619

(22) Filed: Oct. 31, 2023

(51) Int. Cl. B60G 13/00

(52) U.S. Cl. CPC B60G 13/001; B60G 2202/112; B60G 2204/12

(57) ABSTRACT

A mounting bracket assembly for securing a shock absorber to a leaf spring includes a first bracket, a second bracket, a first fastener and a second fastener. The first bracket includes a first fastener receiver and a second fastener receiver. The second bracket includes a first arm, having a third fastener receiver and a fourth fastener receiver, and a second arm having at least one shock mount. The first fastener is received in the first fastener receiver and the third fastener receiver. The second fastener is received in the second fastener receiver and the fourth fastener receiver. The mounting bracket assembly is adapted to clamp the leaf spring with the leaf spring extending between the first bracket, the second bracket, the first fastener and the second fastener.

### TECHNICAL FIELD

This document relates generally to the vehicle equipment field and, more particularly, to new and improved (a) mounting bracket assembly for securing a shock absorber to a vehicle, (b) shock absorber mounting system, and (c) method of mounting a shock absorber to a vehicle.

### BACKGROUND

State of the art mounting of shock absorbers to a vehicle require one to remove the axle u-bolt hardware at each shock absorber mounting point. This is a relatively tedious, time consuming and complicating process. This document relates to new and improved mounting bracket assembly, shock absorber mounting system and method of mounting a shock absorber that mount the shock absorber directly between a leaf spring of the vehicle and a keeper hanging from the frame of the vehicle. Advantageously, there is no need to remove or even loosen the axle u-bolt hardware. As a result, the shock absorber mounting process is greatly simplified and the elapsed time to complete the process may be reduced by as much as 75%. In addition, direct connection of the shock absorber to the leaf spring allow for more efficient and effective damping action.

### SUMMARY

For purposes of this document, the term “vehicle” refers to a trailer or recreational vehicle of any kind including a leaf spring and at least one axle assembly or tandem axle assembly.

In accordance with the purposes and benefits set forth herein, a new and improved mounting bracket assembly is provided for securing a shock absorber to a leaf spring on a vehicle. That mounting bracket assembly comprises, consists of or consists essentially of: (a) a first bracket including a first fastener receiver and a second fastener receiver, (b) a second bracket including a first arm, having a third fastener receiver and a fourth fastener receiver, and a second arm having at least one shock mount, (c) a first fastener received in the first fastener receiver and the third fastener receiver, and (d) a second fastener received in the second fastener receiver and the fourth fastener receiver wherein the first bracket and the second bracket are adapted to clamp the leaf spring with the leaf spring extending between the first bracket, the second bracket, the first fastener and the second fastener.

In at least one of the many possible embodiments of the mounting bracket assembly, the second bracket is substantially L-shaped. The first arm may have a length L1 and the second arm may have a length L2 wherein the ratio of L1:L2 is between about 1.0:1.6 and about 1.0:2.0. In other possible embodiments, the first arm may have a length L1 and the second arm may have a length L2 wherein the ratio of L1:L2 is between about 1.0:1.8 and about 1.0:1.9.

In accordance with yet another aspect, a new and improved shock absorber mounting system, comprises, consists of or consists essentially of: (a) a leaf spring, (b) a keeper adapted for hanging from a vehicle frame, (c) a mounting bracket assembly secured to the leaf spring, and (d) a shock absorber connected at a first end to the mounting bracket assembly and at a second end to the keeper. The mounting bracket assembly includes a first shock mount and the keeper includes a second shock mount.

In at least some embodiments, the shock absorber mounting system includes a first shock fastening member securing the first end of the shock absorber to the first shock mount and a second shock fastening member securing the second end of the shock absorber to the second shock mount.

In one or more embodiments, the mounting bracket assembly includes (a) a first bracket including a first fastener receiver and a second fastener receiver, (b) a second bracket including a first arm, having a third fastener receiver and a fourth fastener receiver, and a second arm having the first shock mount, (c) a first fastener received in the first fastener receiver and the third fastener receiver, and (d) a second fastener received in the second fastener receiver and the fourth fastener receiver wherein the first bracket and the second bracket are adapted to clamp the leaf spring with the leaf spring extending between the first bracket, the second bracket, the first fastener and the second fastener.

The second bracket may be substantially L-shaped. The first arm may have a length L1 and the second arm may have a length L2 wherein the ratio of L1:L2 is between about 1.0:1.6 and about 1.0:2.0. In other possible embodiments, the first arm may have a length L1 and the second arm may have a length L2 wherein the ratio of L1:L2 is between about 1.0:1.8 and about 1.0:1.9.

In accordance with yet another aspect, a new and improved method of mounting a shock absorber to a vehicle comprises, consists of or consists essentially of connecting the shock absorber between a leaf spring and a frame of the vehicle.

Such a method may further include securing a mounting bracket assembly to the leaf spring of the vehicle. Such a method may also include securing a first end of the shock absorber to the mounting bracket assembly and a second end of the shock absorber to a keeper hanging from a frame of the vehicle.

In one or more of the many possible embodiments, the method includes capturing the leaf spring between a first bracket, a second bracket, a first fastener and a second fastener of the mounting bracket assembly. Still further the method includes mounting the shock absorber to the vehicle without loosening axle u-bolt hardware on the vehicle. This simplifies the process and substantially shortens the time required to complete shock absorber mounting.

In the following description, there are shown and described several different embodiments of the new and improved (a) mounting bracket assembly, (b) shock absorber mounting system and (c) method of efficiently mounting a shock absorber to a vehicle. As it should be realized, the assembly, system and method are capable of other, different embodiments and their several details are capable of modification in various, obvious aspects all without departing from the formulation and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein by reference and forming a part of the specification, illustrate several aspects of the new and improved assembly, system and method and together with the description serve to explain certain principles thereof.

FIG. 1 is a detailed perspective view of the first bracket of the new and improve bracket assembly for securing a shock absorber to a leaf spring.

FIG. 2A is a detailed perspective view of the second bracket of the new and improve bracket assembly for securing a shock absorber to a leaf spring.

FIG. 2B is a side elevational view of the second bracket illustrated in FIG. 2A.

FIG. 3 is a side elevational view of a vehicle illustrating the new and improved shock absorber mounting system.

FIG. 4 is a detailed side elevational view showing the connection of the bracket assembly to the leaf spring.

FIG. 5 is a detailed front elevational view showing the connection of the bracket assembly to the leaf spring.

Reference will now be made in detail to the present preferred embodiments of the (a) mounting bracket assembly, (b) shock absorber mounting system and (c) method of efficiently mounting a shock absorber to a vehicle.

### DETAILED DESCRIPTION

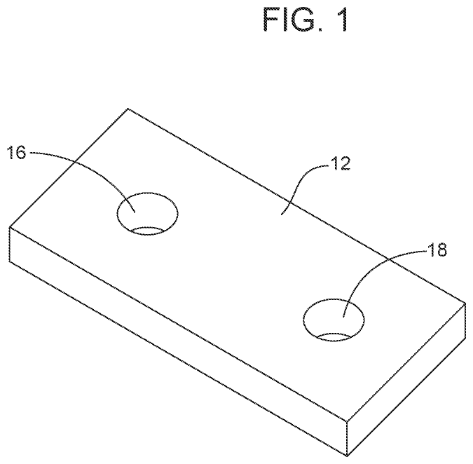

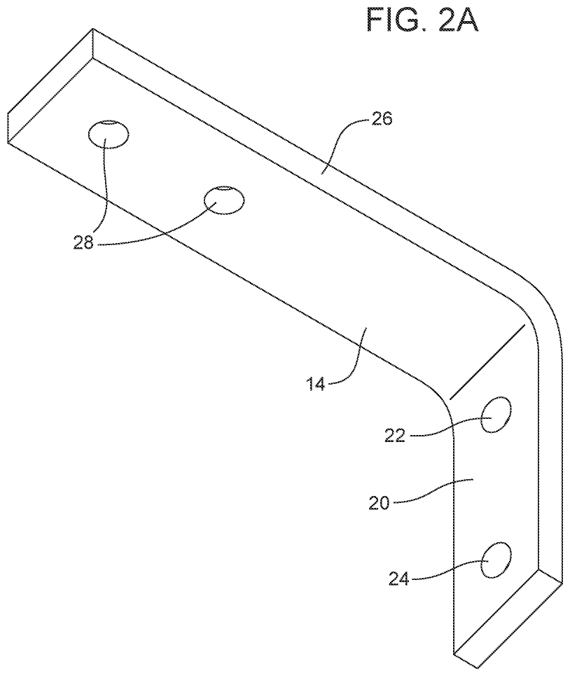

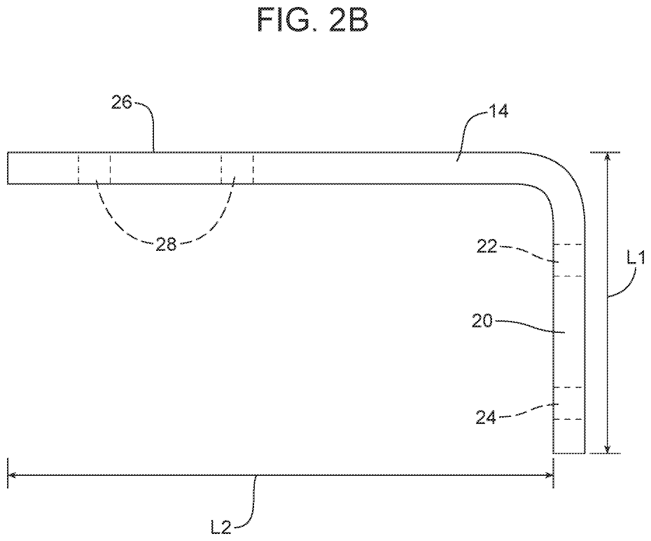

Reference is now made to FIGS. 1-5 illustrating the new and improved mounting bracket assembly 10 for securing a shock absorber 15 to a leaf spring 25. The bracket assembly 10 includes a first bracket 12 and a second bracket 14. As best shown in detail in FIG. 1, the first bracket 12 includes a first fastener receiver 16 and a second fastener receiver 18. As best shown in detail in FIGS. 2A and 2B, the second bracket 14 includes a first arm 20, having a third fastener receiver 22 and a fourth fastener receiver 24, and a second arm 26 having at least one shock mount 28. Two shock mounts 28 are shown in the illustrated embodiment. The second bracket 14 is substantially L-shaped.

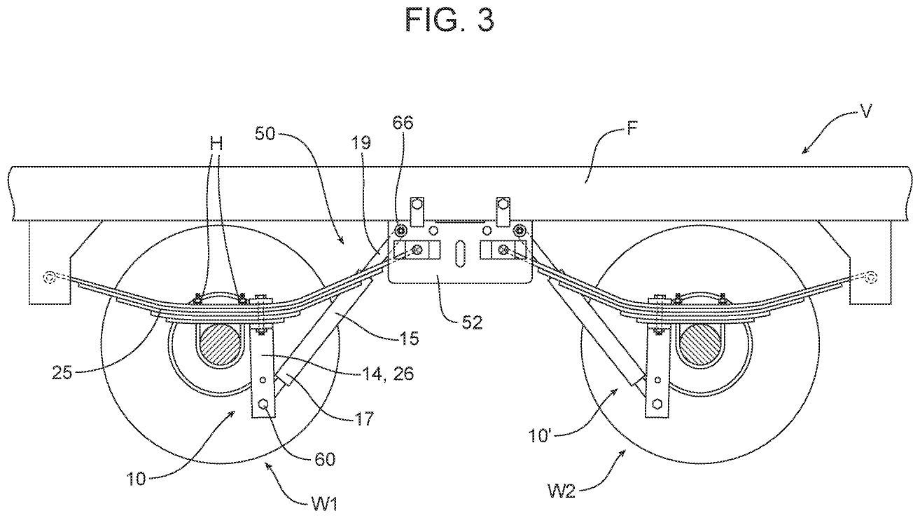

In the illustrated embodiment, the first arm 20 has a length L1 and the second arm has a length L2 wherein the length ratio of L1:L2 is between about 1.0:1.6 and about 1.0:2.0. In one particularly useful embodiment, the length ratio of L1:L2 is between about 1.0:1.8 and about 1.0:1.9. As will be described in detail below, the mounting bracket assembly 10 also includes first and second fasteners 30, 32 adapted to secure the bracket assembly in position on the leaf spring 25 as illustrated in FIGS. 3-5.

Reference is now made to FIG. 3 which illustrates the new and improved shock absorber mounting system 50. The shock absorber mounting system 50 includes: (a) a leaf spring 25, (b) a keeper 52, adapted for hanging from a vehicle frame F, (c) the mounting bracket assembly 10 secured to the leaf spring 25, and (d) a shock absorber 15 connected at a first end 17 to the mounting bracket assembly and at a second end 19 to the keeper. The keeper 52 is more fully described in detail in co-pending U.S. patent application Ser. No. 18/232,915, filed on Aug. 11, 2023, entitled TANDEM AXLE SUSPENSION SYSTEM WITH KEEPER HAVING SLIDING SLIPPER BLOCKS, the full disclosure of which is incorporated herein by reference.

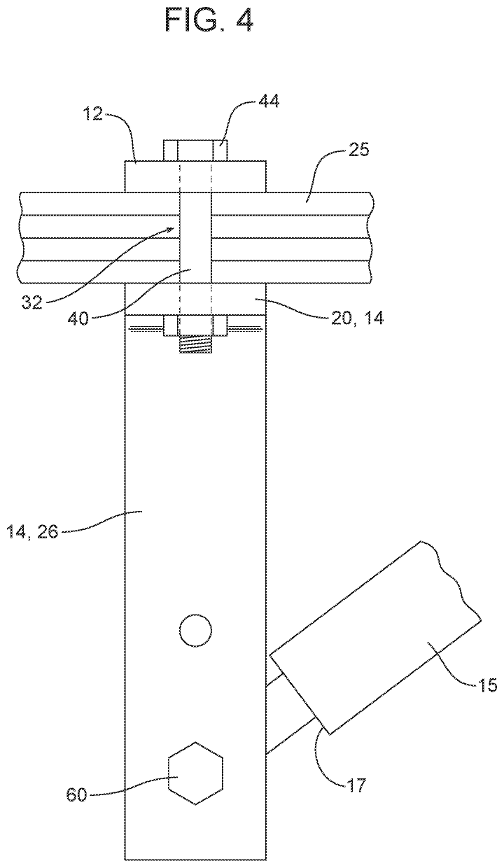

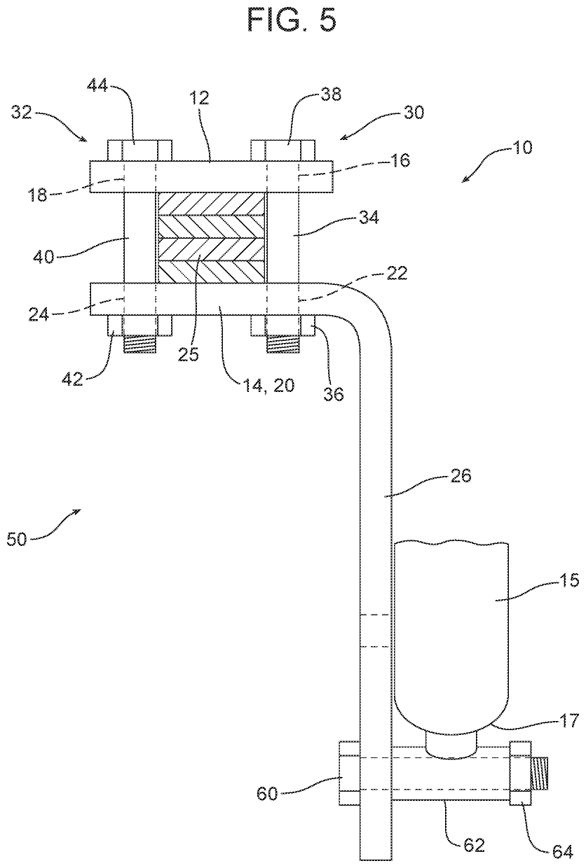

FIGS. 4 and 5 clearly illustrate the manner of mounting the mounting bracket assembly 10 to the leaf spring 25. As best shown in FIGS. 4 and 5, the leaf spring 25 is sandwiched between the overlying first bracket 12 and the underlying first arm 20 of the second bracket 14. The first fastener 30 comprises a bolt 34 and a cooperating lock nut 36. The bolt 34 is received in the first fastener receiver 16, in the first or upper bracket 12, and the third fastener receiver 22 in the second or lower bracket 14, and the lock nut 36 is tightened so that the head 38 of the bolt and the lock nut secure the connection.

Similarly, the second fastener 32 comprises a bolt 40 and a cooperating lock nut 42. The bolt 40 is received in the second fastener receiver 18, in the first or upper bracket 12, and the fourth fastener receiver 24 in the second or lower bracket 14, and the lock nut 42 is tightened so that the head 44 of the bolt and the lock nut secure the connection. As shown in FIG. 5, not only is the leaf spring 25 sandwiched between the two brackets 12, 14 but the leaf spring is also held between the two bolts 34, 40.

A new and improved method of mounting a shock absorber 15 to a trailer or recreational vehicle V includes connecting the shock absorber between the leaf spring 25 and the frame F of the trailer or recreational vehicle V and, more particularly the keeper 52 mounted to the frame. The method includes the step of securing the mounting bracket 10 to the leaf spring 25 as described above and illustrated in FIGS. 3-5. The method also includes the step of securing a first end 17 of the shock absorber 15 to the mounting bracket 10 and the second end 19 of the shock absorber to the keeper 52. Note the mounting bolt 60 that is received through one of the apertures/the shock mount 28 in the mounting assembly 10 and the mounting sleeve 62 of the shock absorber 15 and the cooperating nut 64 that completes the connection between the mounting bracket and the shock absorber. Also note the bolt 66 that completes the connection at the upper end 19 of the shock absorber 15 between the shock absorber and the keeper 52 (see also FIG. 3, the cooperating nut is hidden from view behind the keeper).

As best shown in FIGS. 4 and 5, the method also includes the step of capturing the leaf spring 25 between the first bracket 12, the second bracket 14, the first fastener 34 and the second fastener 40 of the mounting bracket assembly 10.

As shown in FIG. 3, the mounting bracket assembly 10 is used on the first axle and wheel assembly W1 at one side of the vehicle V. A second mounting bracket assembly 10′ is used on the second wheel assembly W2 at the same side of the vehicle V and two more are used on the wheel assemblies at the opposite side (not shown).

Advantageously, the method, shown and described, allows for the mounting of the shock absorber 15 to the vehicle V without loosening the axle U-bolt hardware H. This greatly simplifies the shock absorber mounting process and reduces the elapsed time to complete the process by as much as 75%. In addition, the direct connection of the shock absorber 15 to the leaf spring 25 allows for more efficient and effective damping action.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a mounting bracket assembly”, as used herein, may also refer to, and encompass, a plurality of mounting bracket assemblies.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the mounting bracket assembly, the shock absorber mounting system and the related method of mounting a shock absorber of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

1. A mounting bracket assembly for securing a shock absorber to a leaf spring, comprising:
a first bracket including a first fastener receiver and a second fastener receiver;
a second bracket including a first arm, having a third fastener receiver and a fourth fastener receiver, and a second arm having at least one shock mount;
a first fastener received in the first fastener receiver and the third fastener receiver; and
a second fastener received in the second fastener receiver and the fourth fastener receiver wherein the first bracket and the second bracket are adapted to clamp the leaf spring with the leaf spring sandwiched between the first bracket and the second bracket and held between the first fastener and the second fastener.

2. The mounting bracket assembly of claim 1, wherein the second bracket is substantially L-shaped.

3. The mounting bracket assembly of claim 2, wherein the first arm has a length L1 and the second arm has a length L2 wherein the ratio of L1:L2 is between about 1.0:1.6 and about 1.0:2.0.

4. The mounting bracket assembly of claim 2, wherein the first arm has a length L1 and the second arm has a length L2 wherein the ratio of L1:L2 is between about 1.0:1.8 and about 1.0:1.9.

5. A shock absorber mounting system, comprising:
a leaf spring;
a keeper adapted for hanging from a vehicle frame;
a mounting bracket assembly secured to the leaf spring; and
a shock absorber connected at a first end to the mounting bracket assembly and at a second end to the keeper wherein the mounting bracket assembly includes (a) a first bracket including a first fastener receiver and a second fastener receiver, (b) a second bracket including a first arm, having a third fastener receiver and a fourth fastener receiver, and a second arm having the first shock mount, (c) a first fastener received in the first fastener receiver and the third fastener receiver, and (d) a second fastener received in the second fastener receiver and the fourth fastener receiver wherein the first bracket and the second bracket are adapted to clamp the leaf spring with the leaf spring sandwiched between the first bracket and the second bracket and held between the first fastener and the second fastener.

6. The shock absorber mounting system of claim 5, wherein the mounting bracket assembly includes a first shock mount and the keeper includes a second shock mount.

7. The shock absorber mounting system of claim 6, further including a first shock fastening member securing the first end of the shock absorber to the first shock mount and a second shock fastening member securing the second end of the shock absorber to the second shock mount.

8. (canceled)

9. The shock absorber mounting system of claim 7, wherein the second bracket is substantially L-shaped.

10. The shock absorber mounting system of claim 9, wherein the first arm has a length L1 and the second arm has a length L2 wherein the ratio of L1:L2 is between about 1.0:1.6 and about 1.0:2.0.

11. The shock absorber mounting system of claim 9, wherein the first arm has a length L1 and the second arm has a length L2 wherein the ratio of L1:L2 is between about 1.0:1.8 and about 1.0:1.9.

12. (canceled)

13. (canceled)

14. (canceled)

15. (canceled)

16. (canceled)

17. (canceled)

18. The mounting bracket assembly of claim 1 wherein the first fastener and the second fastener extend outboard of the leaf spring.

19. The shock absorber mounting system of claim 5, wherein the first fastener and the second fastener extend outboard of the leaf spring.
